(19) United States
(12) Patent Application Publication
(10) Pub. No.: US 2026/0191625 A1
(43) Pub. Date: Jul. 9, 2026

(54) INTRAORAL SCANNER ASSEMBLY

(71) Applicant: Planmeca Oy, Helsinki (FI)

(72) Inventors: Timo SILVONEN, Helsinki (FI); Kia ANDERSSON, Helsinki (FI); Sami VARTIAINEN, Helsinki (FI)

(21) Appl. No.: 19/128,406

(22) PCT Filed: Nov. 9, 2023
(86) PCT No.: PCT/FI2023/050623

§ 371 Date: May 8, 2025

Related U.S. Application Data
(60) Provisional application No. 63/424,102, filed on Nov. 9, 2022.

(30) Foreign Application Priority Data
Nov. 10, 2022 (FI) 20220067
Nov. 10, 2022 (FI) 20220068

(51) Int. Cl. A61C 9/00; H05K 7/20

(52) U.S. Cl. CPC A61C 9/0046; A61C 9/0093; H05K 7/20145

(57) ABSTRACT

Intraoral scanning assembly comprising a handheld intraoral scanner and a control arrangement comprising a computer (13), wherein the control arrangement comprises a control console (3), the computer (13) is arranged inside the control console (3) and wherein cooling openings (16) arranged at an upper section of the control console (3). The back section (32) and the top section (33) of the control 7 console (3) meet each other without any abrupt corner but to smoothly converge with each other so as to form a smoothly curving inner surface joining the back section (32) and the top section (33).

### FIELD OF THE INVENTION

The present invention relates to intraoral scanners. More precisely, in one aspect, the invention relates to a control console of an intraoral scanner assembly. In another aspect, the invention relates to mobile intraoral scanner arrangements.

### BACKGROUND OF THE INVENTION

Intraoral scanners are devices used in dentistry to obtain digital im-pressions of intraoral anatomies. Intraoral scanners can be used e.g. when designing crowns, dentures, aligners, and other types of dental prosthetics. Intraoral scanners used in dental field typically operate by projecting light on the area to be imaged and capturing multiple images of the anatomy with the help of an image detector. These images are processed by software to create a 3D surface model of the imaged anatomy.

A typical intraoral scanner arrangement comprises a handheld scanner, a computer, and an image processing software. The computer may be assembled at the dentist's desk and be operated by mains power. A dental care unit via which many instruments used in connection with dental case may be equipped with a holder for a handheld intraoral scanner. Nowadays, also mobile intraoral scanner arrangements are commercially available.

Generating a digital 3D surface module of an intraoral anatomy from images acquired by an intraoral imaging scan requires calculating power. In one aspect, computers generate heat and thus may need to be cooled-an intraoral scan may cause a computer to produce around 200 W heat which should be removed from the vicinity of the computer. In another aspect, mobile arrangements with a battery may be heavy or otherwise clumsy to use, like be prone to topple over.

### BRIEF DESCRIPTION OF THE INVENTION

According to one aspect, a solution relating to cooling a control console comprised in an intraoral scanner assembly is disclosed herein. According to another aspect, a solution is disclosed which relates to a user-friendly mobile intraoral scanner arrangement.

### BRIEF DESCRIPTION OF THE FIGURES

Some details and embodiments are shown in the attached drawings, of which

FIG. 1 presents an intraoral scanner arrangement comprising a control console and a structure enabling the arrangement to be mobile,

FIGS. 2a and 2b present front-bottom and a back-top views of a control console which could correspond to the one shown in FIG. 1,

FIG. 3 presents a cross section of a side view of a control console presenting cooling airflows inside a control console,

FIG. 4 shows an example of components that may be arranged inside the control console, and

FIG. 5 presents an intraoral scanner assembly as integrated with a typical dental care unit.

### DETAILED DESCRIPTION OF THE INVENTION

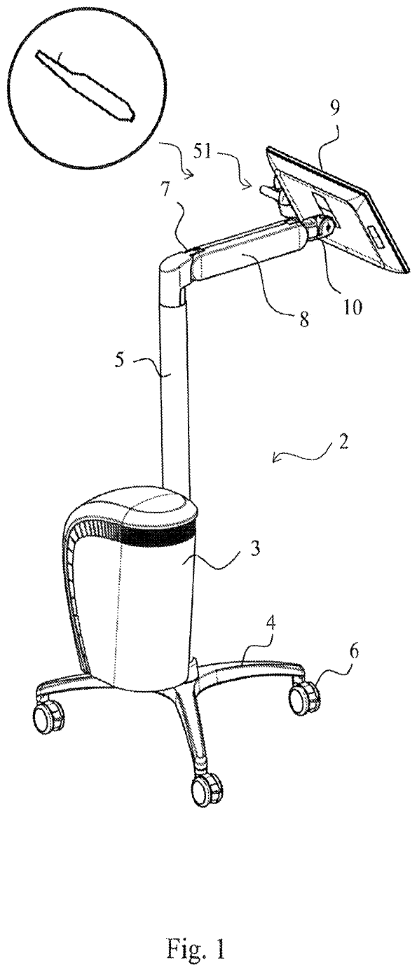

FIG. 1 shows one possible embodiment according to the current disclosure. The intraoral scanner arrangement presented in FIG. 1 comprises a stand 2 with legs 4 and wheels 6 arranged to the legs 4, the legs 4 and wheels 6 forming a lower part of the stand 2. An upper part of the stand 2 comprises a vertical pole 5 having a bottom end and a top end, and the vertical pole 5 is connected to the lower part of the stand 2.

The arrangement further comprises a support arm 8 comprising a first end and a second end, the support arm 8 being connected from its first end via a first articulated construction 7 to the vertical pole 5 at or at the proximity of the top end of the vertical pole 5. A display 9 is connected to the support arm 8 at or at the proximity of the second end of the support arm 8 via a second articulated construction 10. A holder 51 for the handpiece of a handheld intraoral scanner is arranged at the proximity of the display 9.

According to one aspect, as shown in FIG. 1, a control console 3 is positioned at the proximity of the bottom end of the vertical pole 5.

According to one aspect, the control console 3 and the support arm 8 are arranged to extend from the vertical pole 5 in opposite directions.

According to another aspect, as shown in FIG. 1, the stand 2 has three legs 4 extending outwards from the vertical direction in which the vertical pole 5 extends in three directions with equal mutual angles. According to another aspect, the control box 3 is positioned so as to extend from the vertical pole 5 in a direction opposite to a direction in which one of the three legs extends.

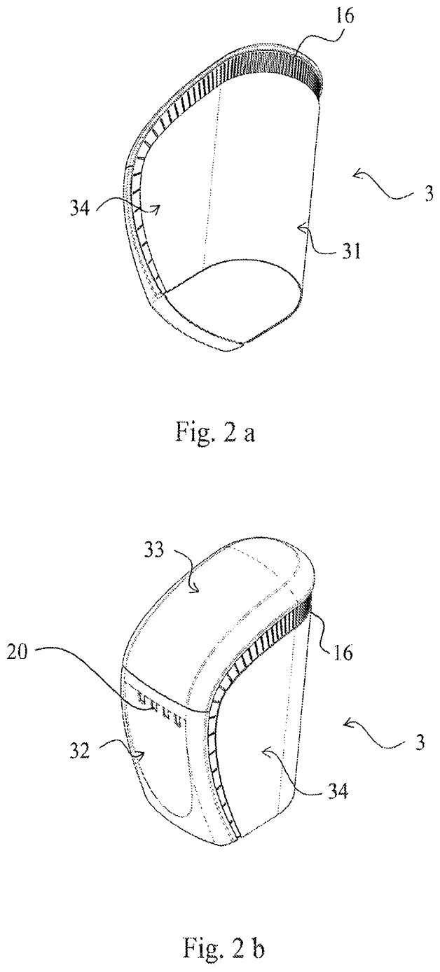

FIGS. 2a and 2b show a front-bottom and a back-top views of a control console 3. The console of these Figs. comprises a front section 31, a back section 32, a top section 33, and side sections 34 meeting said front, back and top sections. FIG. 2b shows connectors 20 arranged on the back side of the control console 3, which may be USB-ports for various accessories or functionalities, besides one for the intraoral scanner. Such and other connectors may be arranged alternatively or additionally on some other surface of the control console 3 as well, like a mains power connector and/or an ethernet connector on the side surface of the control console 3.

The front section 31 of the control console 3 may extend higher than the back section 32, meaning that the top section 33 in that case is not exactly horizontal but ascends when going from the back section 32 towards the front section 31.

The back section 32 may be vertical yet in embodiments of the attached Figs, it is first inclined backwards when going upwards from its lower end. After that section inclined backwards, the back section 32 curves without any abrupt corner to smoothly converge with the top section 33.

Also, the top section 33 itself may be curved while ascending from the direction of the back section 32 towards the frontal end thereof. According to one aspect, the top section surface has its highest point at a small distance prior to reaching the front section 31 of the control console 3.

As shown especially in FIG. 2b, also side sections 34 are arranged to smoothly bend near their back and top ends towards the back section 32 and the top section 33, respectively, without any abrupt corner but to smoothly converge with the back section 32 and the top section 33.

According to one aspect and as shown in FIGS. 2a and 2b, a similar smoothly curving structure is found at the front edges connecting the side sections 34 and the front section 31.

In an embodiment, a set of cooling openings 16 circles the control console 3, extending from near the top of the front section 31 through the side sections 32, or at least either of the side sections 34, again near the top thereof, and continuing down along near the back end of the at least one side section 32.

In an embodiment, the distance between the cooling openings 16 gets smaller when going from the sections at the back of the side section 32 towards the frontal section 31. The individual cooling openings 16 may in such case be of the same size.

In an embodiment, the cooling openings 16 are not of the same size but larger areas, to allow for more air to exit when going towards the frontal section, are realized by having gradually larger openings when going from the back-side end of the set of cooling openings 16 towards the top frontal side.

In an embodiment, individual cooling openings 16 of a set of cooling openings are of the same size yet the distance between the openings gets smaller when going from the sections of the set of cooling openings at back of the side parts of the control console 3 towards the frontal section thereof.

In an embodiment, the set of cooling openings 16 does not end at the very bottom of a side section but at a distance above it.

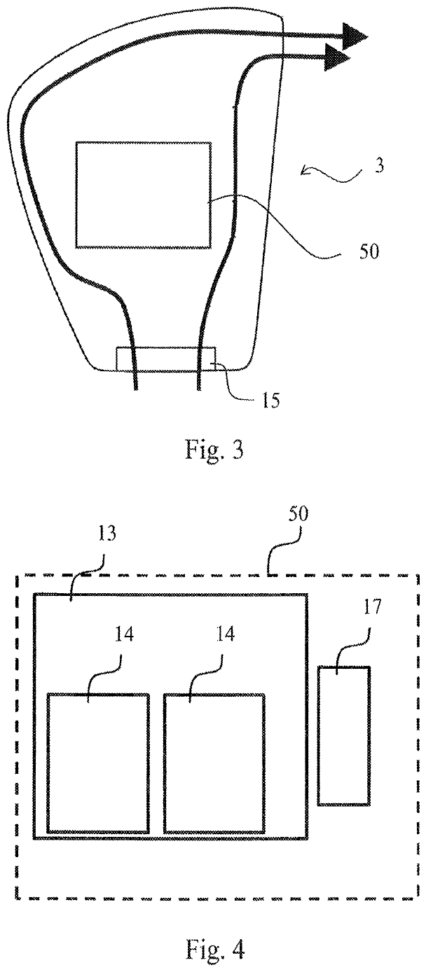

FIG. 3 presents as a side view a cross section of a control console, presenting an example of how cooling may be arranged to take place in the control console 3. In FIG. 3, a fan 15 is arranged at the bottom of the control console 3, while a block 50 in FIG. 3 represents a computer and any other components there may arranged inside the control console 3. The components 50 may be arranged inside the console such that there is room for an airflow next to the inner walls of the control console 3. While not shown in FIG. 3, the cooling openings 16 enable a flow out of the console everywhere along the set of cooling openings 16 yet the shape of the console and the lesser area the openings 16 cover at lower parts of the set of openings 16 causes a major part of the air, which is hottest in the upper parts inside the console housing, out of the console from the top frontal section thereof. That is, the fan 15 pushes air from the bottom towards the top and the airflow is guided to take paths near the inner surfaces of the control console, i.e. to take paths like the ones shown by two arrows in FIG. 3.

FIG. 3 may give an impression that a computer and any other components are positioned quite high within the console but FIG. 3 is only schematic and it is preferable, actually, to arrange the components quite low within the console 3—for air flow reasons yet also for others to be discussed herein.

Depending on which kind and how components are arranged inside the console, a portion of the flow may be directed between the components in the middle of the console 3. FIG. 4 shows an example of components that may be included in the control console, wherein reference number 13 is for a computer, 14 for a battery and 17 for a power source for the computer.

When a control console 3 of an intraoral scanner is designed as described above, one may be able reach temperatures inside the console of about 10° C. lower as compared to if the console would be of a shape of a rectangular box. The arrangement may be able to provide enough cooling even without the fan.

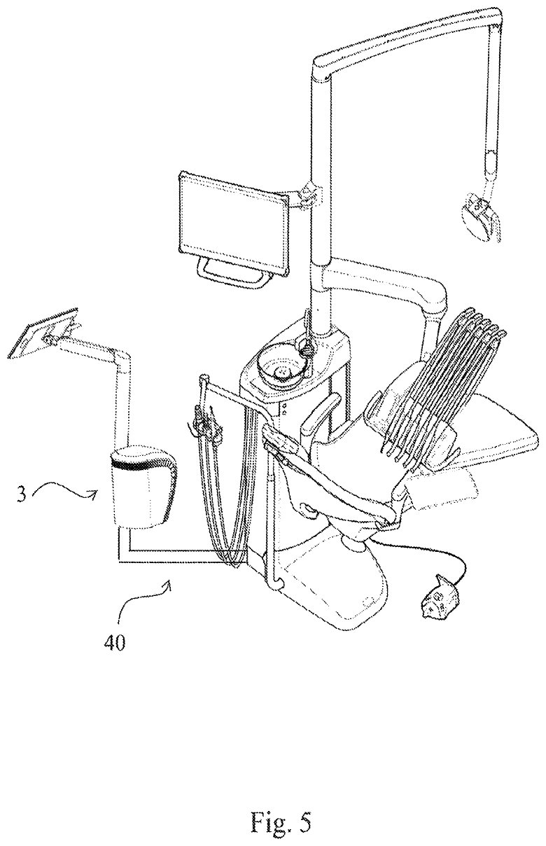

FIG. 5 presents an intraoral scanner arrangement 3 with a connecting construction 40 via which the scanner arrangement is integrated with a typical dental care unit. An example of a typical dental care unit is an apparatus which comprises
a frame part comprising a wall structure extending substantially vertically and a cover structure positioning above the wall structure,
an attaching arrangement arranged at the frame to enable attaching a substantially vertically extending support part to the frame, the attaching arrangement comprising at least a first connecting means, or a substantially vertically extending support part attached to the frame part, the attaching arrangement of the support part comprising at least a first connecting means,
which vertically extending support part is a part of a support arrangement, which is arranged to support at least one of the following components: one or more than one instrument used in dental care, an imaging device used in dental care, an operating light used in dental care, and
a control system of the dental care unit adapted to deliver to said at least one component operating power, fluid and/or control signals needed for its operation.

Further regarding various aspects of this disclosure, some provide solutions for good mobility, stability and ergonomics for an intraoral scanning arrangement, which may also be stored in a relatively small space.

For example, the height position of the console 3 on the vertical pole is preferably as low as possible, near the top of the legs 4 of the stand, and also near the vertical pole 5 in horizontal direction, and between two legs 4 so that the arrangement is easy to move and the mobile console will be protected from unintentional hits. Center of mass can further be kept low, for stability of the arrangement, by placing batteries near the bottom of the console. When locating on the other side of the vertical pole as the support arm and the display, the console functions as a counterweight for them.

The legs 4 of the arrangement preferably have clearance for a foot or a shoe so that one is able to place them under the legs even in the vicinity of a wheel. A clearance from the floor surface may be arranged to be 8-15 cm, preferably at least 10 cm.

As to one aspect, the shape of the control console directs the main airflow to the area at the top of the console that allows for exit of air the most. When the fan is located at the bottom of the console, designed to have smooth curved surfaces from the bottom of the casing to one top side thereof and when there are cooling openings at the side parts which directly, without changing the flow direction, allow for the heat generated by the computer to rise up inside the console, and when the airflow is arranged so that air flows undisturbed from the bottom to the openings in the top part, an efficient heat removal from the console is made possible.

When the shape of the console walls is smooth so as to enable an easy and effortless flow of air inside the casing, which increases cooling efficiency, the fan can be small and can be operated at low speeds, which also makes it possible to have a low-noise cooling arrangement.

According to one aspect of this disclosure, an intraoral scanning assembly is presented which comprises a handheld intraoral scanner and a control arrangement comprising a computer 13, wherein the control arrangement comprises a control console 3 with walls comprising a front section 31, a back section 32, a top section 33, and side sections 34 meeting said front 31, back 32 and top 33 sections, the computer 13 is arranged inside the control console 3, the control console 3 comprises cooling openings 16 arranged at upper section of the control console 3 at a short distance from the top section 33, and wherein the back section 32 and the top section 33 of the control console 3 meet each other without any abrupt corner but to smoothly converge with each other so as to form a smoothly curving inner surface joining the back section 32 and the top section 33, such that air inside the control console 3 may flow upwards towards the cooling openings 16 as directed by the control console walls without meeting any abrupt corner between the back section 32 and top section 33.

The cooling openings 16 may be arranged at upper end of the front section 31 of the control console 3, at a short distance from the top section 33. Alternative or in addition, cooling openings 16 may be arranged at upper end of at least one of the side sections 34 of the control console 3, at a short distance from the top section 33.

Further alternatively or in addition, cooling openings 16 may be arranged on at least one of the side sections 34 at a short distance from the back section 32.

According to one aspect, the top section 33 of the control console 3 is generally ascending from a proximity of the back section 32 towards the front section 31 thereof. A set of cooling openings 16 may be arranged at upper end of at least one of the side sections 34 of the control console 3, each cooling opening of the set of cooling openings 16 being arranged at an equal short distance from the top section 33. This results in a structure where cooling openings closer to the frontal end of the control console are on a higher horizontal level than those closer to the back section of the control console.

The cooling openings 16 may form a set of cooling openings 16 comprising a subset of cooling openings 16 along the set of cooling openings 16 providing a larger area of openings for air to be exhausted from the control console 3, wherein said subset providing the larger area of openings 16 for air to be exhausted from the control console 3 is arranged to comprise more cooling openings 16 within that given subsection of the set of cooling openings 16, or to comprise larger cooling openings 16 within that given subsection of the set of cooling openings 16.

According to one aspect, the cooling openings 16 form a set of cooling openings 16 comprising a subset of cooling opening providing the largest area of openings for air to be exhausted from the control console 3, said subset providing the largest area of openings locating on the front section 31 of the control console 3 at a short distance from the top section 33.

According to another aspect, the cooling openings 16 form a set of cooling openings 16, the set of cooling openings 16 extending from an area located at the proximity of the top end of the front section 31 to at least one of the side sections 34 at a proximity of the top end of the side section and further, at a proximity of the back end of the at least one side sections, downwards on the side section 34. Along a set of cooling openings 16 extending from the lower end of the at least one side section 34, a combined area of openings which a subsection of a given length of the cooling openings 16 provides may gradually increase towards the front section 31 of the set of cooling openings 16.

According to one aspect, the back section 32 of the control console 3 is inclined to extend, a distance as starting from its lower end, away from the front section 31 prior to curving towards and meeting the top section 33.

The top section 33 of the control console 3 may while generally ascending from the proximity of the back section 32 towards the front section 31 not be planar but comprises an ascending concave inner surface for the airflow inside the control console 3.

The front section 31, the back section 32, the top section 33, and the side sections 34 of the control console 3 when meeting another section may meet that other section with a rounded corner so as to smoothly converge with said other section.

According to one aspect, the assembly comprises a fan 15 arranged inside the control console 3 at the proximity of its bottom.

The assembly optionally comprises a battery component and optionally other components relating to operating the computer, and all components arranged inside the control console 3 may be positioned a distance away from walls defined by all of the front section 31, the back section 32, the top section 33, and the side sections 34 so as to leave room for an airflow along inner surfaces of said sections.

According to one aspect, the assembly comprises a connecting construction designed to enable integrating the scanner assembly with a dental care unit, which assembly and dental care unit when connected constitute an arrangement in which the dental care unit part of the arrangement comprises
a frame part comprising a wall structure extending substantially vertically and a cover structure positioning above the wall structure,
an attaching arrangement arranged at the frame to enable attaching a substantially vertically extending support part to the frame, the attaching arrangement comprising at least a first connecting means, or a substantially vertically extending support part attached to the frame part, the attaching arrangement of the support part comprising at least a first connecting means,
which vertically extending support part is a part of a support arrangement, which is arranged to support at least one of the following components: one or more than one instrument used in dental care, an imaging device used in dental care, an operating light used in dental care, and
a control system of the dental care unit adapted to deliver to said at least one component operating power, fluid and/or control signals needed for its operation.

According to one aspect, the assembly further comprises
a stand 2 with legs 4 and wheels 6 arranged to the legs 4, the legs 4 and wheels 6 forming a lower part of the stand 2;
an upper part of the stand 2 comprising a vertical pole 5 having a bottom end and a top end, the vertical pole 5 being connected to the lower part of the stand 2;
a support arm 8 comprising a first end and a second end, the support arm 8 being connected from its first end via a first articulated construction 7 to the vertical pole 5 at or at the proximity of the top end of the vertical pole 5;
a display 9 connected to the support arm 8 at or at the proximity of its second end via a second articulated construction 10;
a holder 51 to receive an intraoral scanner handpiece; wherein the control arrangement comprises said control console and the computer is arranged inside the control console 3 and the control console 3 is positioned at the proximity of the bottom end of the vertical pole 5; and wherein
   the control console 3 and the support arm 8 are arranged to extend outwards from the vertical pole 5 on the same vertical plane in opposite directions, and/or wherein
   the stand 2 has three legs 4 which extend outwards from the vertical pole 5 at equal mutual angels and the control console 3 is positioned to extend from the vertical pole 5 on the same vertical plane and in a direction opposite to a direction in which one of said three legs extends from the vertical pole 5.

The control console 3 may be dimensioned such that it gets positioned partly above two adjacent legs 4.

1. Intraoral scanning assembly comprising a handheld intraoral scanner and a control arrangement comprising a computer, wherein the control arrangement comprises a control console with walls comprising a front section, a back section, a top section, and side sections meeting said front, back and top sections, the computer is arranged inside the control console, the control console comprises cooling openings arranged at upper section of the control console at a short distance from the top section, and wherein the back section and the top section of the control console meet each other without any abrupt corner but to smoothly converge with each other so as to form a smoothly curving inner surface joining the back section and the top section, such that air inside the control console may flow upwards towards the cooling openings as directed by the control console walls without meeting any abrupt corner between the back section and top section.

2. Assembly according to claim 1, comprising cooling openings arranged at upper end of the front section of the control console, at a short distance from the top section.

3. Assembly according to claim 1, comprising cooling openings arranged at upper end of at least one of the side sections of the control console, at a short distance from the top section.

4. Assembly according to claim 1, comprising cooling openings arranged on at least one of the side sections at a short distance from the back section.

5. Assembly according to claim 1, wherein the top section is generally ascending from a proximity of the back section towards the front section.

6. Assembly according to claim 5, comprising a set of cooling openings arranged at upper end of at least one of the side sections of the control console, each cooling opening of the set of cooling openings being arranged at an equal short distance from the top section.

7. Assembly according to claim 1, wherein the cooling openings form a set of cooling openings comprising a subset of cooling openings along the set of cooling openings providing a larger area of openings for air to be exhausted from the control console, wherein said subset providing the larger area of openings for air to be exhausted from the control console is arranged to comprise more cooling openings within that given subsection of the set of cooling openings, or to comprise larger cooling openings within that given subsection of the set of cooling openings.

8. Assembly according to claim 1, wherein the cooling openings form a set of cooling openings comprising a subset of cooling opening providing the largest area of openings for air to be exhausted from the control console, said subset providing the largest area of openings locating on the front section of the control console at a short distance from the top section.

9. Assembly according to claim 1, wherein the cooling openings form a set of cooling openings, the set of cooling openings extending from an area located at the proximity of the top end of the front section to at least one of the side sections at a proximity of the top end of the side section and further, at a proximity of the back end of the at least one side sections, downwards on the side section.

10. Assembly according to claim 9, wherein along a set of cooling openings extending from the lower end of the at least one side section, a combined area of openings which a subsection of a given length of the cooling openings provides gradually increases towards the front section of the set of cooling openings

11. Assembly according to claim 1, wherein the back section is inclined to extend, a distance as starting from its lower end, away from the front section prior to curving towards and meeting the top section.

12. Assembly according to claim 5, wherein the top section while generally ascending from the proximity of the back section towards the front section is not planar but comprises an ascending concave inner surface for the airflow inside the control console

13. Assembly according to claim 1, wherein the front section, the back section, the top section, and the side sections when meeting another section meets that other section with a rounded corner so as to smoothly converge with said other section.

14. Assembly according to claim 1, wherein the assembly comprises a fan arranged inside the control console at the proximity of its bottom.

15. Assembly according to claim 1, wherein the assembly optionally comprises a battery component and optionally other components relating to operating the computer, and wherein all components arranged inside the control console are positioned a distance away from walls defined by all of the front section, the back section, the top section, and the side sections so as to leave room for an airflow along inner surfaces of said sections.

16. Assembly according to claim 1, further comprising a connecting construction designed to enable integrating the scanner assembly with a dental care unit, which assembly and dental care unit when connected constitute an arrangement in which the dental care unit part of the arrangement comprises
a frame part comprising a wall structure extending substantially vertically and a cover structure positioning above the wall structure,
an attaching arrangement arranged at the frame to enable attaching a substantially vertically extending support part to the frame, the attaching arrangement comprising at least a first connecting means, or
a substantially vertically extending support part attached to the frame part, the attaching arrangement of the support part comprising at least a first connecting means, which vertically extending support part is a part of a support arrangement, which is arranged to support at least one of the following components: one or more than one instrument used in dental care, an imaging device used in dental care, an operating light used in dental care, and
a control system of the dental care unit adapted to deliver to said at least one component operating power, fluid and/or control signals needed for its operation.

17. Assembly according to claim 1, further comprising
a stand with legs and wheels arranged to the legs the legs and wheels forming a lower part of the stand;
an upper part of the stand comprising a vertical pole having a bottom end and a top end, the vertical pole being connected to the lower part of the stand;
a support arm comprising a first end and a second end, the support arm being connected from its first end via a first articulated construction to the vertical pole at or at the proximity of the top end of the vertical pole;
a display connected to the support arm at or at the proximity of its second end via a second articulated construction;
a holder to receive an intraoral scanner handpiece;
wherein the control arrangement comprises said control console and the computer is arranged inside the control console and the control console is positioned at the proximity of the bottom end of the vertical pole; and wherein the control console and the support arm are arranged to extend outwards from the vertical pole on the same vertical plane in opposite directions, and/or wherein
the stand has three legs which extend outwards from the vertical pole at equal mutual angels and the control console is positioned to extend from the vertical pole on the same vertical plane and in a direction opposite to a direction in which one of said three legs extends from the vertical pole.

18. Assembly according to claim 17, wherein the control console is dimensioned such that it gets positioned partly above two adjacent legs.
